(19) United States
(12) Patent Application Publication
(10) Pub. No.: US 2025/0083670 A1
(43) Pub. Date: Mar. 13, 2025

(54) AUTONOMOUS DRIVING VEHICLE AND CONTROL METHOD THEREOF

(71) Applicants: HYUNDAI MOTOR COMPANY, Seoul (KR); KIA CORPORATION, Seoul (KR)

(72) Inventor: Ha Neul Kim, Incheon (KR)

(73) Assignees: HYUNDAI MOTOR COMPANY, Seoul (KR); KIA CORPORATION, Seoul (KR)

(21) Appl. No.: 18/825,889

(22) Filed: Sep. 5, 2024

(30) Foreign Application Priority Data
Sep. 8, 2023 (KR) 10-2023-0119496

(51) Int. Cl. B60W 30/12; B60W 30/09; B60W 30/095; B60W 60/00

(52) U.S. Cl. CPC B60W 30/12; B60W 30/09; B60W 30/0953; B60W 30/0956; B60W 60/001; B60W 2554/4041; B60W 2554/4042

(57) ABSTRACT

A method of controlling an autonomous vehicle includes, when a lane following assist (LFA) function is activated, controlling, by a processor, driving of the autonomous vehicle on a lane based on a preset reference following line. The method also includes determining, by the processor, a surrounding situation of the lane by receiving sensing information from a plurality of sensors while driving on the lane. The method additionally includes controlling, by the processor, driving of the autonomous vehicle on the lane based on a corrected following line that is corrected from the preset reference following line based on a result of the determining.

### CROSS-REFERENCE TO RELATED APPLICATION

This application claims the benefit of and priority to Korean Patent Application No. 10-2023-0119496, filed on Sep. 8, 2023, the entire contents of which are hereby incorporated herein by reference.

### TECHNICAL FIELD

The present disclosure relates to an autonomous vehicle and a control method thereof.

### BACKGROUND

Autonomous vehicles may reduce driver fatigue by performing driving, braking, and steering on behalf of the driver. Autonomous vehicles are recently required to have the ability to adaptively respond to surrounding situations that change in real time while driving.

An autonomous vehicle may drive by following only a center of a lane, regardless of the lane on which the autonomous vehicle is driving or whether a nearby vehicle is driving.

For example, when the autonomous vehicle drives by following only the center of the lane even in a case where there is a structure near the left or right side of the lane ahead or a vehicle with the large width approaches from behind the autonomous vehicle, the driver may be psychologically afraid and perform sudden steering control, which may cause a dangerous situation.

The statements in this section merely provide background information related to the present disclosure and may not constitute prior art.

### SUMMARY

Aspects of the present disclosure provide an autonomous vehicle and a control method thereof that may correct a following position on a lane according to a surrounding environment or a position of a target vehicle during autonomous driving.

The technical objects to be achieved by the present disclosure are not limited to those described above. Other technical objects not described above may also be more clearly understood by those having ordinary skill in the art from the following description.

According to an embodiment of the present disclosure, a method of controlling an autonomous vehicle is provided. The includes, when a lane following assist (LFA) function is activated, controlling, by a processor, driving of the autonomous vehicle in a lane based on a preset reference following line. The method also includes determining, by the processor, a surrounding situation by use of sensing information from a plurality of sensors while the autonomous vehicle is driving in the lane. The method additionally includes controlling, by the processor, driving of the autonomous vehicle in the lane based on a corrected following line that is corrected from the preset reference following line based on a result of the determining.

In at least one embodiment of the present disclosure, the method may further include determining, by the processor, the corrected following line within such a range that the autonomous vehicle does not depart from the lane.

In at least one embodiment of the present disclosure, determining the corrected following line includes determining the corrected following line based on a line of the lane and a lateral position of the autonomous vehicle.

In at least one embodiment of the present disclosure, the method may further include determining, by the processor, a path of the autonomous vehicle based on the corrected following line.

In at least one embodiment of the present disclosure, determining the corrected following line includes, when an obstacle is recognized as being ahead on the lane or a neighboring lane next to the lane, determining the corrected following line based on the line of the lane and the lateral position of the autonomous vehicle.

In at least one embodiment of the present disclosure, the method may further include, when a vehicle is recognized as being ahead on a neighboring lane next to the lane, setting, by the processor, the recognized vehicle as a target vehicle. The method may also include determining, by the processor, the corrected following line based on a lateral position of the target vehicle or a speed of the target vehicle.

In at least one embodiment of the present disclosure, the method may further include, when a vehicle is recognized as being behind on a neighboring lane next to the lane, setting, by the processor, the recognized vehicle as a target vehicle. The method may also include determining, by the processor, the corrected following line based on a lateral position of the target vehicle or a speed of the target vehicle.

In at least one embodiment of the present disclosure, the method may further include determining, by the processor, a path of the target vehicle by use of sensing information from the plurality of sensors.

In at least one embodiment of the present disclosure, the method may further include maintaining, by the processor, the corrected following line or returning to the reference following line based on the path of the autonomous vehicle and the path of the target vehicle.

According to another embodiment of the present disclosure, an autonomous vehicle is provided. The autonomous vehicle includes a memory storing computer-readable instructions. The autonomous vehicle also includes a processor coupled to the memory. The processor is configured to, when a lane following assist (LFA) function is activated, control driving of the autonomous vehicle in a lane based on a preset reference following line. The processor is also configured to determine a surrounding situation by use of sensing information from a plurality of sensors while driving in the lane. The processor is additionally configured to control driving of the autonomous vehicle in the lane based on a corrected following line that is corrected from the preset reference following line based on a result of the determining.

In at least one embodiment of the present disclosure, the processor is further configured to determine the corrected following line within such a range that the autonomous vehicle does not depart from the lane.

In at least one embodiment of the present disclosure, the processor is further configured to determine the corrected following line based on a line of the lane and a lateral position of the autonomous vehicle.

In at least one embodiment of the present disclosure, the processor is further configured to determine a path of the autonomous vehicle based on the corrected following line.

In least one embodiment of the present disclosure, the processor is further configured to, when an obstacle is recognized as being ahead on the lane or a neighboring lane next to the lane, determine the corrected following line based on the line of the lane and the lateral position of the autonomous vehicle.

In at least one embodiment of the present disclosure, the processor is further configured to, when a vehicle is recognized as being ahead on a neighboring lane next to the lane, set the recognized vehicle as a target vehicle. The processor may additionally be configured to determine the corrected following line based on a lateral position of the target vehicle or a speed of the target vehicle.

In at least one embodiment of the present disclosure, the processor is further configured to, when a vehicle is recognized as being behind on a neighboring lane next to the lane, set the recognized vehicle as a target vehicle. The processor may additionally be configured to determine the corrected following line based on a lateral position of the target vehicle or a speed of the target vehicle.

In at least one embodiment of the present disclosure, the processor is further configured to, when the target vehicle is set, determine a path of the target vehicle by receiving sensing information from the plurality of sensors.

In at least one embodiment of the present disclosure, the processor is further configured to maintain the corrected following line or return to the preset reference following line based on the path of the autonomous vehicle and the path of the target vehicle.

According to embodiments of the present disclosure, an autonomous vehicle and a control method thereof may control a following position on a lane to respond to a surrounding environment or surrounding situation in which the autonomous vehicle is driving by using at least one sensor, thereby improving the stability of autonomous driving or driving of the autonomous vehicle.

In embodiments, the autonomous vehicle and control method thereof may detect in advance a dangerous situation with respect to a front structure or a vehicle approaching from behind by using at least one sensor and control a following position on a lane based on detecting the dangerous situation to prevent a safety accident in advance.

The effects that can be achieved from the present disclosure are not limited to those described above. Other effects not described above should be more clearly understood by those having ordinary skill in the art from the following description.

### BRIEF DESCRIPTION OF THE DRAWINGS

FIG. 1 is a block diagram illustrating an autonomous vehicle, according to an embodiment of the present disclosure.

FIGS. 2-5 are diagrams illustrating a method of controlling a following position on a lane, according to an embodiment of the present disclosure.

FIG. 6 is a diagram illustrating a method of controlling an autonomous vehicle, according to an embodiment of the present disclosure.

### DETAILED DESCRIPTION OF THE DISCLOSURE

Hereinafter, embodiments of the present disclosure are described in detail with reference to the accompanying drawings. In the accompanying drawings, the same or similar elements are given the same reference numerals regardless of reference symbols, and a repeated description thereof has been omitted. Further, in describing the embodiments, where it was determined that a detailed description of related publicly known technology may obscure the gist of the embodiments described herein, the detailed description thereof has been omitted.

As used herein, the terms “include,” “comprise,” and “have,” or the like, specify the presence of stated features, numbers, operations, elements, components, and/or combinations thereof. Such terms do not preclude the presence or addition of one or more other features, numbers, operations, elements, components, and/or combinations thereof. In addition, when describing embodiments with reference to the accompanying drawings, like reference numerals refer to like components and a repeated description related thereto is omitted.

The terms “unit” and “control unit” included in names such as a vehicle control unit (VCU) may be terms widely used in the naming of a control device or controller configured to control vehicle-specific functions. Such terms may not refer to a generic function unit. For example, each controller or control unit may include a communication device that communicates with other controllers or sensors to control a corresponding function, a memory that stores an operating system (OS) or logic commands and input/output information, and at least one processor that performs determination, calculation, selection, and the like necessary to control the function.

When a component, device, element, or the like of the present disclosure is described as having a purpose or performing an operation, function, or the like, the component, device, or element should be considered herein as being “configured to” meet that purpose or perform that operation or function.

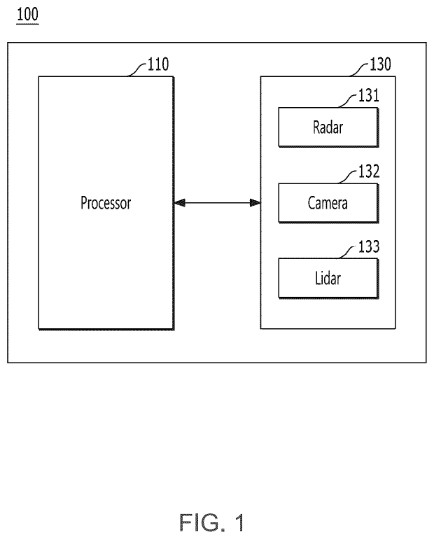

FIG. 1 is a block diagram illustrating an autonomous vehicle, according to an embodiment of the present disclosure.

Referring to FIG. 1, according to an embodiment of the present disclosure, an autonomous vehicle 100 may include a processor 110 and a plurality of sensors 130.

The plurality of sensors 130 may include sensors mounted on the front, rear, and sides of the autonomous vehicle 100. The plurality of sensors 130 may sense in real time the surroundings of the autonomous vehicle 100 while the autonomous vehicle 100 is parked/stopped or is driving. The plurality of sensors 130 may provide sensing information obtained by the sensing to the processor 110.

For example, the plurality of sensors 130 may include a radar 131, a camera 132, and a lidar 133. The radar 131 may also be referred to herein as a first sensor, the camera 132 may also be referred to herein as a second sensor, and the lidar 133 may also be referred to herein as a third sensor.

The radar 131 may be provided as one or more radars in the autonomous vehicle 100. The radar 131 may measure a relative speed and relative distance with respect to a recognized object, together with a wheel speed sensor (not shown) mounted on the autonomous vehicle 100. For example, the radar 131 may be mounted at the rear and on the sides of the autonomous vehicle 100 to recognize an object present behind (also simply referred to herein as a rear object). The rear object may include a rear vehicle, a rear target vehicle, a target vehicle, or the like.

The camera 132 may be provided as one or more cameras in the autonomous vehicle 100. The camera 132 may include, for example, a wide-angle camera. The camera 132 may capture images of objects around the autonomous vehicle 100 and their states and output image data based on the captured information. For example, as described in more detail below, the camera 132 may be mounted at the rear and on the sides of the autonomous vehicle 100 to recognize objects present behind or on the sides of the autonomous vehicle 100.

The lidar 133 may be provided as one or more lidars in the autonomous vehicle 100. The lidar 133 may irradiate a laser pulse to an object, measure a time at which the laser pulse reflected from the object within a measurement range returns, sense information such as a distance to the object, a direction and speed of the object, and/or the like, and output lidar data based on the sensed information. The object may be an obstacle, a vehicle, a person, a thing, and the like present outside the autonomous vehicle 100.

When a lane following assist (LFA) function is activated while the autonomous vehicle 100 is driving on a lane, the processor 110 may control the autonomous vehicle 100 to drive on the lane based on a preset reference following line. The preset reference following line may be a center line of the lane. The center line may be defined as a virtual center line located at the center of both lines of the lane. The center line may be a virtual line arranged longitudinally parallel to both lines of the lane or to the lane.

While the autonomous vehicle 100 is driving, the processor 110 may receive sensing information from the plurality of sensors 130 and may determine a surrounding situation of the lane. For example, the processor 110 may receive the sensing information sensed through a front camera, a radar at a front corner, and a radar at a rear corner. The sensing information may include, for example, information on lanes, guardrails disposed on the left or right side of a front lane, rubber cones, vehicles driving on the left or right side of the front lane, trucks or trailers driving on the left or right side of a rear lane, and/or the like.

As described in more detail below, the processor 110 may control the autonomous vehicle 100 to drive on the lane based on a corrected following line obtained by correcting the reference following line based on a result of the determination.

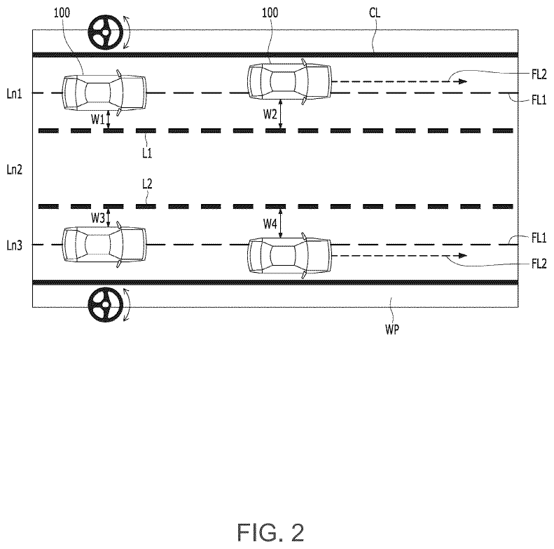

FIGS. 2-5 are diagrams illustrating a method of controlling a following position on a lane, according to an embodiment of the present disclosure.

Referring to FIGS. 2-5, when an LFA function is activated, the processor 110 may control the autonomous vehicle 100 to drive on a lane based on a preset reference following line (e.g., following line 1 (FL1)). The processor 110 may determine a surrounding situation of the lane by receiving sensing information from the plurality of sensors 130 while the autonomous vehicle 100 is driving. The processor 110 may control the autonomous vehicle 100 to drive on the lane based on a corrected following line (e.g., following line 2 (FL2)) that is obtained by correcting the reference following line FL1 based on a result of the determination.

As shown in FIG. 2, a road may include at least one lane and at least one line. For example, the road may include a first lane (e.g., Lane1 (Ln1)), a second lane (e.g., Lane2 (Ln2)), and a third lane (e.g., Lane3 (Ln3)), and a first line (e.g., Line1 (L1)) and a second line (e.g., Line2 (L2)).

The first line L1 may be a broken line demarcating the first lane Ln1 and the second lane Ln2.

The second line L2 may be a broken line demarcating the second lane Ln2 and the third lane Ln3.

The first lane Ln1 may be a lane closest to the median or center line CL. The first lane Ln1 may be an individual passage formed between the center line CL and the first line L1 to allow vehicles to travel therethrough.

The second lane Ln2, which is a neighboring lane adjacent to the first lane Ln1, may be an individual passage formed between the first line L1 and the second line L2 to allow vehicles to travel therethrough. The second lane Ln2 may be present between the first lane Ln1 and the third lane Ln3.

The third lane Ln3, which is a neighboring lane adjacent to the second lane Ln2, may be an individual passage formed between the second lane L2 and a walking path WP along which pedestrians pass, allowing vehicles to travel therethrough. The third lane Ln3 may be a lane closest to the walking path WP.

The processor 110 may analyze a line on the lane and a lateral position of the autonomous vehicle 100 using the sensing information provided by the plurality of sensors 130 and may determine the corrected following line FL2 based on a result of the analysis. In this case, a lateral direction of the autonomous vehicle 100 may refer to a direction that intersects a longitudinal direction in which the autonomous vehicle 100 is driving on the lane of the autonomous vehicle 100.

For example, when it is determined that the autonomous vehicle 100 is driving on the first lane Ln1 using the sensing information provided by the plurality of sensors 130, the processor 110 may determine the corrected following line FL2 such that the autonomous vehicle 100 is located closer to the center line CL from the preset reference following line FL1 by analyzing lines of the lane and the lateral position of the autonomous vehicle 100. Accordingly, a distance between the autonomous vehicle 100 and the first line L1 after the correction may become longer than a distance between the autonomous vehicle 100 and the first line L1 before the correction. In this case, the reference following line FL1 may be a center line CL or a virtual center line CL of the lane.

In addition, when it is determined that the autonomous vehicle 100 is driving on a last lane, which is the third lane Ln3, using the sensing information provided by the plurality of sensors 130, the processor 110 may determine the corrected following line FL2 such that the autonomous vehicle 100 is located closer to the walking path WP from the preset reference following line FL1 by analyzing the lines of the lane and the lateral position of the autonomous vehicle 100. Accordingly, a distance between the autonomous vehicle 100 and the second line L2 after the correction may become longer than a distance between the autonomous vehicle 100 and the second line L2 before the correction.

In addition, when an obstacle 10 is recognized ahead on the lane or a neighboring lane next to the lane in a process of determining the surrounding situation of the lane, the processor 110 may determine the corrected following line FL2 based on the lines of the lane and the lateral position of the autonomous vehicle 100.

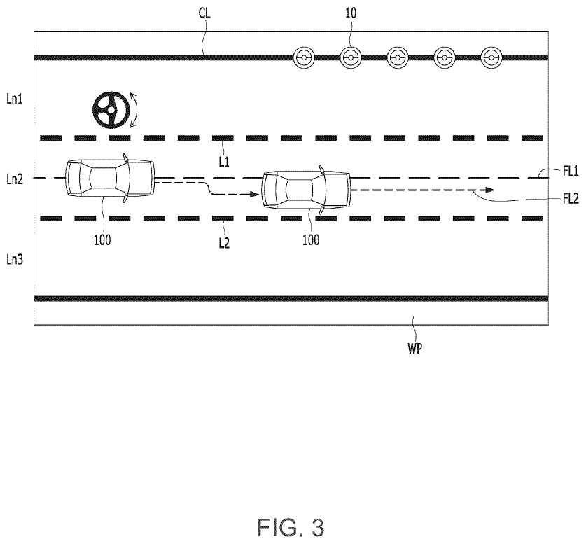

As shown in FIG. 3, when an obstacle 10 is recognized ahead on the first line L1 between the first lane Ln1 and the second lane Ln2 in a process of determining a surrounding situation of the second lane Ln2, the processor 110 may analyze lines of the lane and a lateral position of the autonomous vehicle 100 to determine the corrected following line FL2 such that the autonomous vehicle 100 is located closer to the second lane Ln2 from the preset reference following line FL1. Accordingly, a distance between the autonomous vehicle 100 and the first line L1 after the correction may become longer than a distance between the autonomous vehicle 100 and the first line L1 before the correction. The obstacle 10 may be, for example, a structure such as a guardrail or rubber cone.

In addition, when a vehicle is recognized behind on a neighboring lane next to the lane in a process of determining a surrounding situation of the lane, the processor 110 may set the recognized vehicle as a target vehicle 200 and may determine the corrected following line FL2 based on a lateral position of the set target vehicle 200 or a speed of the target vehicle 200.

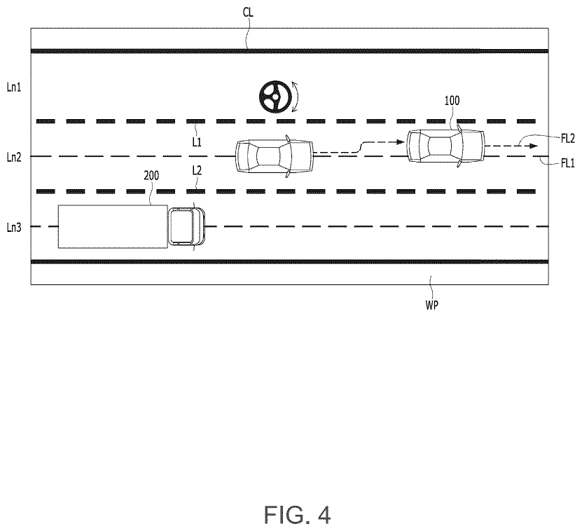

As shown in FIG. 4, when a vehicle is sensed behind on the third lane Ln3 in a process of determining a surrounding situation of the second lane Ln2, the processor 110 may set the sensed vehicle as a target vehicle 200.

Subsequently, the processor 110 may analyze a lateral position of the set target vehicle 200 or a speed of the target vehicle 200 to determine the corrected following line FL2 to be closer to the first line L1 from the preset reference following line FL1. Accordingly, the autonomous vehicle 100 driving on the second lane Ln2 may recede relatively farther from the target vehicle 200 driving on the third lane Ln3.

The processor 110 may calculate a path of the autonomous vehicle 100 based on the corrected following line FL2 and may calculate a path of the target vehicle 200 by receiving sensing information about the set target vehicle 200 from the plurality of sensors 130.

However, the present disclosure is not limited thereto. For example, when it is determined that the speed of the target vehicle 200 is higher than that of the autonomous vehicle 100, the processor 110 may quickly correct the reference following line FL1 to the corrected following line FL2 before an arrival at a safety area formed behind the autonomous vehicle 100.

Subsequently, when the set target vehicle 200 passes by the autonomous vehicle 100 and is recognized as being ahead of the autonomous vehicle 100, the processor 110 may return to using the reference following line FL1 from the corrected following line FL2. That is, the processor 110 may maintain the corrected following line FL2 or return to the reference following line FL1 based on the path of the autonomous vehicle 100 and the path of the target vehicle 200.

In addition, when a vehicle is recognized as being ahead on a neighboring lane next to the lane in a process of determining a surrounding situation of the lane, the processor 110 may set the recognized vehicle as a target vehicle 200 and may determine the corrected following line FL2 based on a lateral position of the set target vehicle 200 or a speed of the target vehicle 200.

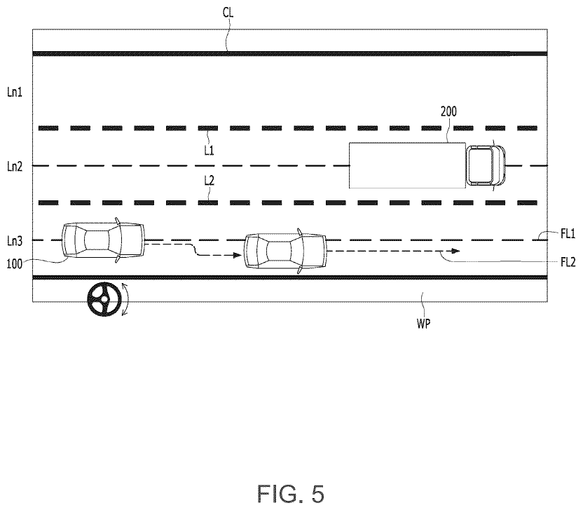

As shown in FIG. 5, when a vehicle is sensed as being ahead on the second lane Ln2 in a process of determining a surrounding situation of the third lane Ln3, the processor 110 may set the sensed vehicle as a target vehicle 200.

Subsequently, the processor 110 may analyze a lateral position of the set target vehicle 200 or a speed of the target vehicle 200 and may determine the corrected following line FL2 to be closer to the walking path from the preset reference following line FL1. Accordingly, the autonomous vehicle 100 driving on the third lane Ln3 may recede relatively farther from the target vehicle 200 driving on the second lane Ln2.

The processor 110 may calculate a path of the autonomous vehicle 100 based on the corrected following line FL2 and calculate a path of the target vehicle 200 by receiving sensing information from the plurality of sensors 130.

However, the present disclosure is not limited thereto. For example, when it is determined that the speed of the set target vehicle 200 is lower than that of the autonomous vehicle 100, the processor 110 may quickly correct the reference following line FL1 to the corrected following line FL2 before an arrival at a safety area formed ahead of the autonomous vehicle 100.

Subsequently, when the autonomous vehicle 100 passes by the set target vehicle 200, and the target vehicle 200 is recognized as being behind the autonomous vehicle 100, the processor 110 may return to using the reference following line FL1 from the corrected following line FL2. Accordingly, the processor 110 may maintain the corrected following line FL2 or return to the reference following line FL1 based on a path of the autonomous vehicle 100 and a path of the target vehicle 200.

As described above with reference to FIGS. 2-5, the autonomous vehicle 100 may determine the corrected following line FL2 within a range that does not depart from a driving lane, under the control of the processor 110.

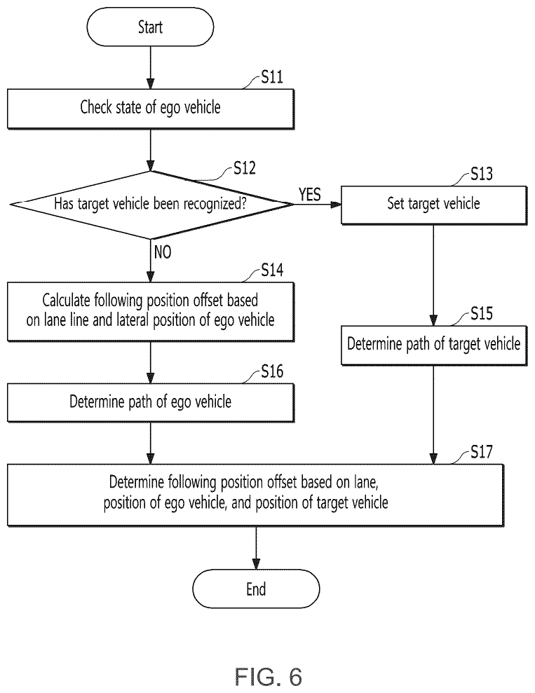

FIG. 6 is a diagram illustrating a method of controlling an autonomous vehicle, according to an embodiment of the present disclosure.

Referring to FIG. 6, a method of controlling the autonomous vehicle 100 according to an embodiment of the present disclosure is as follows.

In a step or operations S11, under the control of the processor 110, the autonomous vehicle 100 may check a driving state of the autonomous vehicle 100. For example, under the control of the processor 110, the autonomous vehicle 100 may check whether an LFA function is activated. When the LFA function is activated, the autonomous vehicle 100 may drive on a lane based on a preset reference following line FL1.

Under the control of the processor 110, the autonomous vehicle 100 may receive sensing information from the plurality of sensors 130 while driving on the lane and determine a surrounding situation of the lane.

In a step or operation S12, under the control of the processor 110, the autonomous vehicle 100 may determine the surrounding situation of the lane and check whether a vehicle is sensed ahead or behind.

For example, under the control of the processor 110, when the vehicle is sensed (Yes in the step or operation S12), the autonomous vehicle 100 may set the sensed vehicle as a target vehicle 200 in a step or operation S13.

In a step or operation S15, under the control of the processor 110, the autonomous vehicle 100 may calculate a path of the target vehicle 200 by receiving sensing information about the set target vehicle 200 from the plurality of sensors 130.

Under the control of the processor 110, when the vehicle is not sensed (No in the step or operation S12), the autonomous vehicle 100 may determine whether an obstacle on the driving lane or ahead is recognized.

Under the control of the processor 110, the autonomous vehicle 100 may correct a reference following line FL1 to a corrected following line FL2 based on a result of the determination. For example, in a step or operation S14, under the control of the processor 110, the autonomous vehicle 100 may analyze the lane, lines, and a lateral position of the autonomous vehicle 100 and may calculate an offset following position based on a result of the analysis. This is described in detail above with reference to FIGS. 2-5, and a detailed description thereof is therefore omitted here.

In a step or operation S16, under the control of the processor 110, the autonomous vehicle 100 may calculate a path of the autonomous vehicle 100 based on the corrected following line FL2.

Subsequently, under the control of the processor 110, the autonomous vehicle 100 may maintain the corrected following line FL2 or return to the reference following line FL1 based on the path of the autonomous vehicle 100 and the path of the target vehicle 200. For example, in a step or operation S17, under the control of the processor 110, the autonomous vehicle 100 may analyze the path of the autonomous vehicle 100 and the path of the target vehicle 200 and calculate an offset following position based on a result of the analysis. This is described in detail above with reference to FIGS. 2-5, and a detailed description thereof is therefore omitted here.

Embodiments of the present disclosure may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, or the like.

The foregoing detailed description should not be construed as restrictive but as illustrative in all respects. The scope of the present disclosure should be determined by reasonable interpretation of the appended claims, and all changes and modifications within the equivalent scope of the present disclosure are included in the scope of the present disclosure.

What is claimed is:

1. A method of controlling an autonomous vehicle, the method comprising:
when a lane following assist (LFA) function is activated, controlling, by a processor, driving of the autonomous vehicle in a lane based on a preset reference following line;
determining, by the processor, a surrounding situation by use of sensing information from a plurality of sensors while driving in the lane; and
controlling, by the processor, driving of the autonomous vehicle in the lane based on a corrected following line that is corrected from the preset reference following line based on a result of the determining.

2. The method of claim 1, further comprising:
determining, by the processor, the corrected following line within such a range that the autonomous vehicle does not depart from the lane.

3. The method of claim 2, wherein determining the corrected following line includes determining the corrected following line based on a line of the lane and a lateral position of the autonomous vehicle.

4. The method of claim 3, further comprising determining, by the processor, a path of the autonomous vehicle based on the corrected following line.

5. The method of claim 4, wherein determining the corrected following line includes, when an obstacle is recognized as being ahead on the lane or a neighboring lane next to the lane, determining the corrected following line based on the line of the lane and the lateral position of the autonomous vehicle.

6. The method of claim 4, further comprising:
when a vehicle is recognized as being ahead on a neighboring lane next to the lane, setting, by the processor, the recognized vehicle as a target vehicle; and
determining, by the processor, the corrected following line based on a lateral position of the target vehicle or a speed of the target vehicle.

7. The method of claim 4, further comprising:
when a vehicle is recognized as being behind on a neighboring lane next to the lane, setting, by the processor, the recognized vehicle as a target vehicle; and
determining, by the processor, the corrected following line based on a lateral position of the target vehicle or a speed of the target vehicle.

8. The method of claim 7, further comprising determining, by the processor, a path of the target vehicle by use of sensing information from the plurality of sensors.

9. The method of claim 8, further comprising maintaining, by the processor, the corrected following line or returning to the preset reference following line based on the path of the autonomous vehicle and the path of the target vehicle.

10. An autonomous vehicle comprising:
a memory storing computer-readable instructions; and
a processor coupled to the memory, the processor configured to control to
when a lane following assist (LFA) function is activated, control the autonomous vehicle to drive in a lane based on a preset reference following line;
determine a surrounding situation by use of sensing information from a plurality of sensors while the autonomous
vehicle is driving in the lane; and
control the autonomous vehicle to drive in the lane based on a corrected following line that is corrected from the preset reference following line based on a result of the determining.

11. The autonomous vehicle of claim 10, wherein the processor is further configured to determine the corrected following line within such a range that the autonomous vehicle does not depart from the lane.

12. The autonomous vehicle of claim 11, wherein the processor is further configured to determine the corrected following line based on a line of the lane and a lateral position of the autonomous vehicle.

13. The autonomous vehicle of claim 12, wherein the processor is further configured to determine a path of the autonomous vehicle based on the corrected following line.

14. The autonomous vehicle of claim 13, wherein the processor is further configured to, when an obstacle is recognized as being ahead on the lane or a neighboring lane next to the lane, determine the corrected following line based on the line of the lane and the lateral position of the autonomous vehicle.

15. The autonomous vehicle of claim 13, wherein the processor is further configured to:
when a vehicle is recognized as being ahead on a neighboring lane next to the lane, set the recognized vehicle as a target vehicle; and
determine the corrected following line based on a lateral position of the target vehicle or a speed of the target vehicle.

16. The autonomous vehicle of claim 13, wherein the processor is further configured to:
when a vehicle is recognized as being behind on a neighboring lane next to the lane, set the recognized vehicle as a target vehicle; and
determine the corrected following line based on a lateral position of the target vehicle or a speed of the target vehicle.

17. The autonomous vehicle of claim 15, wherein the processor is further configured to, when the target vehicle is set, determine a path of the target vehicle by receiving sensing information from the plurality of sensors.

18. The autonomous vehicle of claim 17, wherein the processor is further configured to maintain the corrected following line or return to the preset reference following line based on the path of the autonomous vehicle and the path of the target vehicle.
